(19) United States
(12) Patent Application Publication
(10) Pub. No.: US 2008/0035706 A1
(43) Pub. Date: Feb. 14, 2008

(54) Wire-bonding apparatus and wire-bonding method thereof

(75) Inventors: Ho-Ming Tong, Taipei (TW); Kao-Ming Su, Kaohsiung (TW); Chao-Fu Weng, Tainan (TW); Teck-Chong Lee, Kaohsiung (TW); Chian-Chi Lin, Tainan (TW); Chia-Jung Tsai, Tainan (TW); Chih-Nan Wei, Kaohsiung (TW); Song-Fu Yang, Kaohsiung (TW)

Correspondence Address: BIRCH STEWART KOLASCH & BIRCH, PO BOX 747, FALLS CHURCH, VA, 22040-0747, US

(73) Assignee: Advanced Semiconductor Engineering, Inc.

(21) Appl. No.: 11/646,304

(22) Filed: Dec. 28, 2006

(30) Foreign Application Priority Data
Aug. 14, 2006 (TW) 95129814

(51) Int. Cl. B23K 20/12

(52) U.S. Cl. 228/112.1

(57) ABSTRACT

A wire-bonding apparatus is used for wire-bonding at least a first chip and a second chip on a substrate at the same time. The wire-bonding apparatus includes at least a first capillary, a second capillary, a driving unit, a processing unit and a database. The driving unit is used for driving the first capillary and the second capillary. The processing unit is used for outputting a command to the driving unit to control the first capillary and the second capillary. The database is used for storing an operating parameter data. The processing unit controls the first capillary and the second capillary according to the operating parameter data.

This application claims the benefit of Taiwan application Serial No. 95129814, filed AUG. 14, 2006, the subject matter of which is incorporated herein by reference.

### BACKGROUND OF THE INVENTION

1. Field of the Invention

The invention relates in general to a wire-bonding apparatus and a wire-bonding method thereof, and more particularly to a wire-bonding apparatus with at least two capillaries capable of wire-bonding chips at the same time and a wire-bonding method thereof.

2. Description of the Related Art

Recently, the demand for all kinds of integrated circuits (IC) increases rapidly as the era of consumer electronic products has come. Accordingly, the demand for IC packaging capacity increases as well. Therefore, it is very important to increase the packaging efficiency and capacity for increasing competitiveness of packaging companies.

Electric contacts of an integrated circuit are electrically connected to leads on a substrate in a wire-bonding process. Then, the integrated circuit is packaged to become an electronic device to be assembled later. Conventionally, each substrate can be wire-bonded by only one wire-bonding apparatus. As a result, the speed of wire-bonding can not be increased greatly without expanding the producing line.

### SUMMARY OF THE INVENTION

It is therefore an object of the invention to provide a wire-bonding apparatus and a wire-bonding method thereof. At least two capillaries are provided to wire-bond chips at the same time. Therefore, the wire-bonding speed is increased greatly.

The invention achieves the above-identified object by providing a wire-bonding apparatus used for wire-bonding a first chip and a second chip on a substrate at the same time. The wire-bonding apparatus includes at least a first capillary, a second capillary, a driving unit, a processing unit and a database. The driving unit is used for driving the first capillary and the second capillary. The processing unit is used for outputting a command to the driving unit to control the first capillary and the second capillary. The database stores an operating parameter data. The processing unit controls the first capillary and the second capillary according to the operating parameter data.

The invention achieves the above-identified object by providing a wire-bonding method of a wire-bonding apparatus. The wire-bonding apparatus includes at least a first capillary and a second capillary. The wire-bonding apparatus is used for wire-bonding at least a first chip and a second chip on a substrate at the same time. The wire-bonding method includes following steps. First, coordinates of the first chip and the second chip are obtained. Next, it is determined whether a distance between the first chip and the second chip is greater than a predetermined distance or not. When the distance between the first chip and the second chip is greater than the predetermined distance, the first capillary and the second capillary wire-bond the first chip and the second chip at the same time.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a functional block diagram of a wire-bonding apparatus according to a preferred embodiment of the invention;

FIG. 2 illustrates the wire-bonding apparatus and a substrate with several chips; and

FIG. 3 illustrates a flow chart of wire-bonding method of the wire-bonding apparatus according to the preferred embodiment of the invention

### DETAILED DESCRIPTION OF THE INVENTION

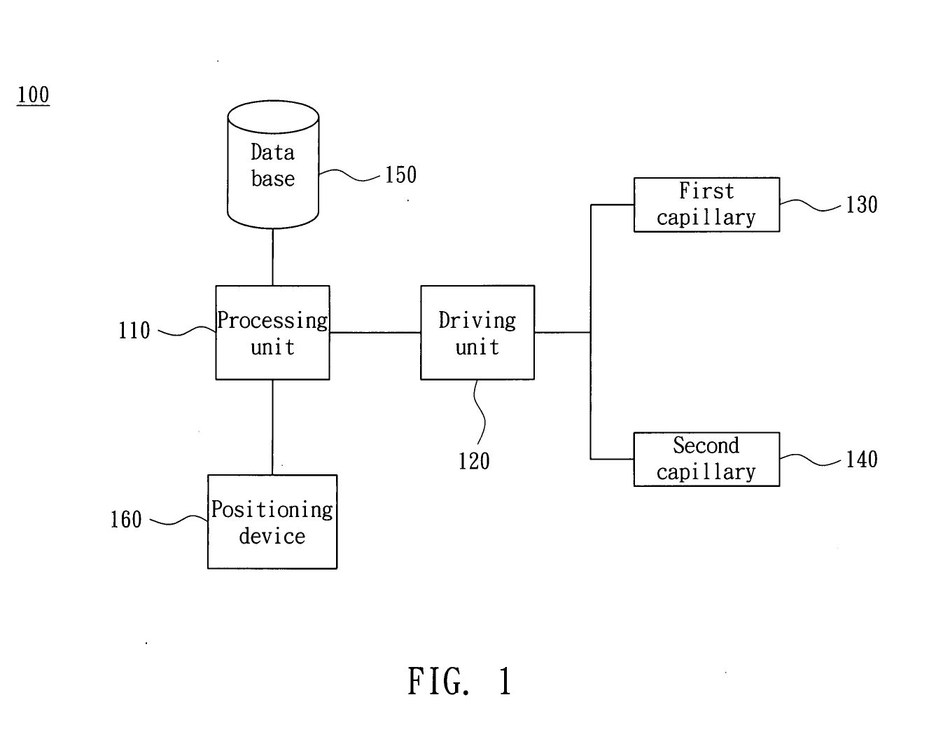

FIG. 1 illustrates a functional block diagram of a wire-bonding apparatus according to a preferred embodiment of the invention. Please referring to FIG. 1, a wire-bonding apparatus 100 is used for wire-bonding at least a first chip and a second chip (not shown in FIG. 1) on a substrate at the same time. The wire-bonding apparatus 100 includes a first capillary 130, a second capillary 140, a driving unit 120 and a processing unit 110. The driving unit 120, such as a driving motor, is used for driving the first capillary 130 and the second capillary 140. The processing unit 110 is used for outputting a command to the driving unit 120 to control the movement and wire-bonding of the first capillary 130 and the second capillary 140. For example, the processing unit 110 is a microprocessor or an application specific integrated circuit (ASIC).

Moreover, the wire-bonding apparatus 100 further includes a database 150 used for storing an operating parameter data. The processing unit 110 controls the first capillary 130 and the second capillary 140 according to the operating parameter data. The operating parameter data includes the distance between chips on the substrate, the size of the chips and the coordinates of the chips. When the first capillary 130 and the second capillary 140 wire-bonds the chips at the same time, the coordinates are used for determining whether the distance between the first capillary 130 and the second capillary 140 is within a safe range. Also, the coordinates are used for positioning the first capillary 130 and the second capillary 140 before wire-bonding the chips.

Furthermore, anyone who has ordinary skill in the field of the invention knows that the invention is not limited thereto. For example, the wire-bonding apparatus 100 is a single wire-bonding apparatus with both the first capillary 130 and the second capillary 140. Or, the wire-bonding apparatus 100 includes two wire-bonding apparatuses with single capillary. The processing unit 110 controls the two wire-bonding apparatuses with single capillary at the same time. Besides, the driving unit 120 can be a driving motor in each wire-bonding apparatus with single capillary. Or, the driving unit 120 is an integrated driving motor used to control the first capillary 130 and the second capillary 140 at the same time.

Moreover, the wire-bonding apparatus 100 further includes a positioning device 160 used for confirming a first position of the first chip and a second position of the second chip. The processing unit 110 controls the first capillary 130 and the second capillary 140 according to the first position and the second position. In other words, the positioning device 160 helps to determine if the first capillary 130 and the second capillary 140 are positioned correctly. The positioning device 160 in the present embodiment includes at least a charge coupled device (CCD). For example, the first capillary 130 includes a CCD, and the second capillary 140 includes another CCD as well. After the CCD receives the image of the first capillary 130, the second capillary 140 and the substrate, the image shows on a screen to manually determine whether the first capillary 130 and the second capillary 140 are correctly positioned. Or, after the CCD receives the image of the first capillary 130, the second capillary 140 and the substrate, the processing unit 110 or another computer coupled with the wire-bonding apparatus 100 determines whether the first capillary 130 and the second capillary 140 are positioned correctly. In the present embodiment, the first chip and the second chip are arranged along the same line, such as the same row or the same column, on the substrate. The first capillary 130 and the second capillary 140 moves and wire-bonds the chips along the line.

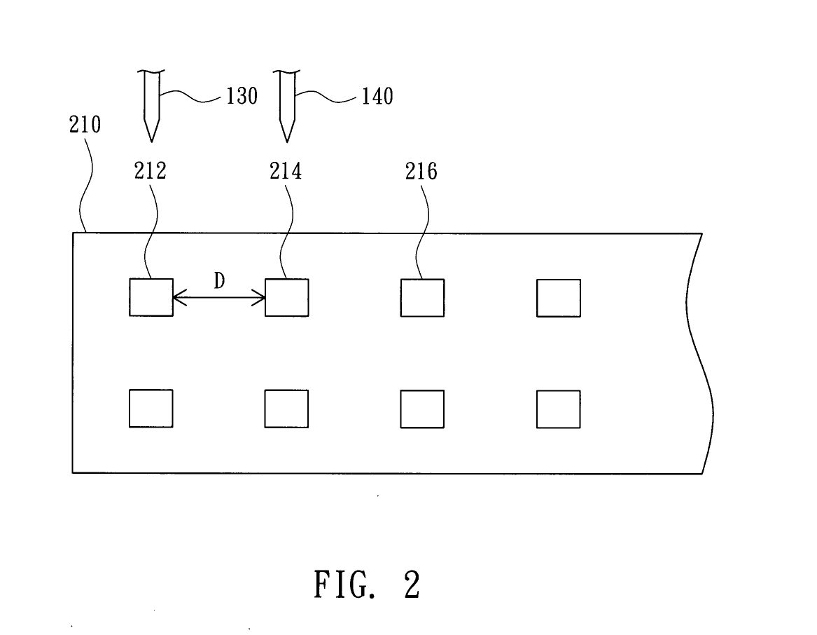

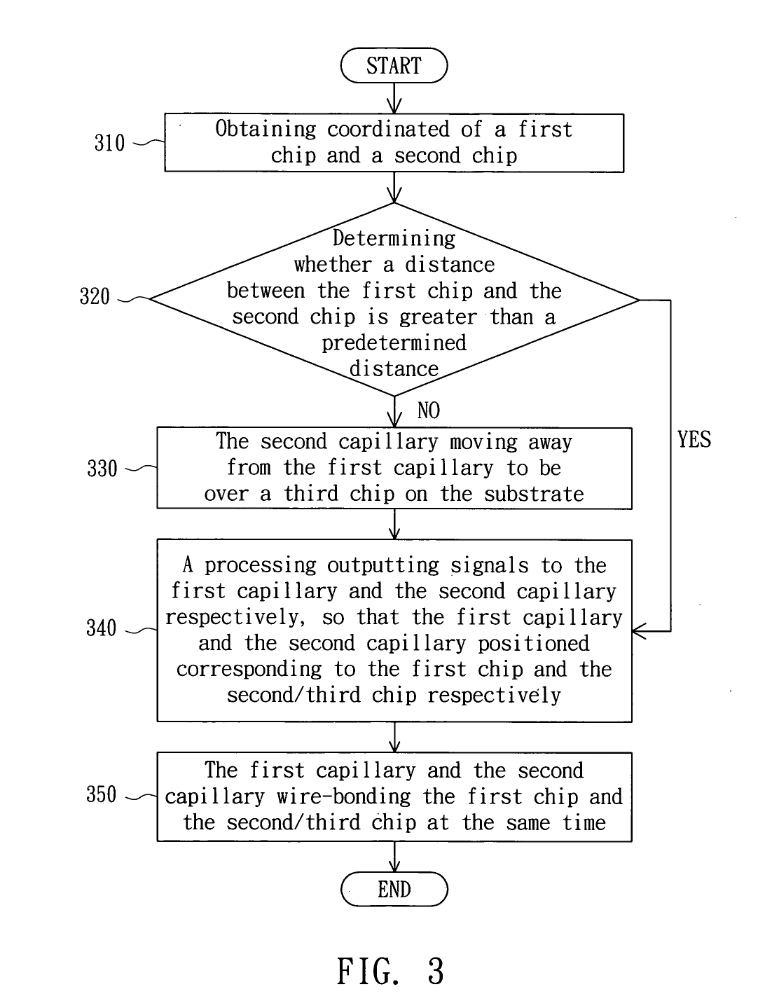

FIG. 2 illustrates the wire-bonding apparatus and the substrate with the chips. FIG. 3 illustrates a flow chart of wire-bonding method of the wire-bonding apparatus according to the preferred embodiment of the invention. Please refer to FIGS. 1˜3 at the same time.

Please refer to FIG. 2. First, in a step 310, the coordinates of the first chip 212 and the second chip 214 on the substrate 210 are obtained. Preferably, the coordinates are obtained from the database 150 by the processing unit 110.

Next, in a step 320, it is determined whether the distance D between the first chip 212 and the second chip 214 is greater than the predetermined distance or not. Preferably, the predetermined distance is stored in the database 150. The step 320 prevents the first capillary 130 and the second capillary 140 from colliding with each other when the distance D is too small.

Therefore, when the distance D is less than the predetermined distance, the second capillary 140 moves away from the first capillary 130 to be over a third chip 216, as shown in a step 330. In the present embodiment, the first chip 212, the second chip 214 and the third chip 216 are arranged substantially along a line on the substrate 210, such as a row. For example, the first capillary 130 and the second capillary 140 move and wire-bond the chips along the same row. However, the invention is not limited thereto. For example, the first chip 212, the second chip 214 and the third chip 216 are arranged in the same column, and the first capillary 130 and the second capillary 140 move and wire-bond the chips along the same column.

Then, in a step 340, the processing unit 110 outputs signals to the first capillary 130 and the second capillary 140. As a result, the first capillary 130 and the second capillary 140 are positioned corresponding to the first chip 212 and the third chip 216 respectively.

Afterwards, in a step 350, the first capillary 130 and the second capillary 140 wire-bond the first chip 212 and the third chip 216 at the same time.

In the step 320, when the distance D between the first chip 212 and the second chip 214 is greater than the predetermined distance, the method goes to the step 350. The processing unit 110 outputs the signals to the first capillary 130 and the second capillary 140 respectively. As a result, the first capillary 130 and the second capillary 140 are positioned corresponding to the first chip 212 and the second chip 214 respectively. Then, the first capillary 130 and the second capillary 140 wire-bond the first chip 212 and the second chip 214 respectively at the same time.

After wire-bonding the first chip 212 and the second chip 214 or the third chip 216 respectively, the first capillary 130 and the second capillary 140 move and then wire-bond the next two chips along the same row or the same column. In the present embodiment, the first capillary 130 and the second capillary 140 move along the same row. Basically, the first capillary 130 and the second capillary 140 are positioned only in the beginning of wire-bonding. Also, the distance between the first capillary 130 and the second capillary 140 is determined only in the beginning of wire-bonding. The following chips are arranged with the same distance from the adjacent ones. Therefore, the first capillary 130 and the second capillary 140 only need to move the same distance to be positioned corresponding to the next two chips and then wire-bond the chips until all the chips on the substrate 210 are wire-bonded.

However, anyone who has ordinary skill in the field of the invention knows that the invention is not limited thereto. For example, the wire-bonding apparatus 100 includes more than two capillaries. As long as the capillaries wire-bond the chips along the same line at the same time, the invention encompasses such modification. Furthermore, the invention can be applied to a chip-bonding apparatus. The first capillary 130 and the second capillary 140 are replaced by chip-bonders. Then, the chips are wire-bonded by the same method.

In the wire-bonding apparatus and the wire-bonding method thereof according to the present embodiment of the invention, at least two capillaries bond the chips along the same line at the same time. Therefore, the speed of wire-bonding is increased greatly without expanding the producing line.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wire-bonding apparatus used for wire-bonding at least a first chip and a second chip on a substrate at the same time, the wire-bonding apparatus comprising:
at least a first capillary and a second capillary;
a driving unit used for driving the first capillary and the second capillary;
a processing unit used for outputting a command to the driving unit to control the first capillary and the second capillary; and
a database used for storing an operating parameter data, wherein the processing unit controls the first capillary and the second capillary according to the operating parameter data.

2. The apparatus according to claim 1, wherein the operating parameter data comprises a distance between the chips, the size of the chips and coordinates of the chips.

3. The apparatus according to claim 1 further comprising a positioning device used for confirming a first location of the first chip and a second location of the second chip, wherein the processing unit controls the first capillary and the second capillary according to the first location and the second location.

4. The apparatus according to claim 3, wherein the positioning device comprises at least a charge coupled device (CCD).

5. The apparatus according to claim 1, wherein the first chip and the second chip are arranged substantially along a line on the substrate, the first capillary and the second capillary moving and wire-bonding the chips along the line.

6. A wire-bonding method of a wire-bonding apparatus, the wire-bonding apparatus comprising at least a first capillary and a second capillary, the wire-bonding apparatus used for wire-bonding a first chip and a second chip on a substrate at the same time, the method comprising:
(a) obtaining coordinates of the first chip and the second chip;
(b) determining if a distance between the first chip and the second chip is greater than a predetermined distance; and
(c) driving the first capillary and the second capillary to wire-bond the first chip and the second chip when the distance between the first chip and the second chip is greater than the predetermined distance.

7. The method according to claim 6, wherein the first capillary and the second capillary are positioned corresponding to the first chip and the second chip respectively.

8. The method according to claim 6 further comprising:
(d) moving the second capillary to a third chip when the distance between the first chip and the second chip is less than the predetermined distance.

9. The method according to claim 8 further comprising:
(e) wire-bonding the first chip and the third chip at the same time.

10. The method according to claim 8, wherein the first capillary and the second capillary are positioned corresponding to the first chip and the third chip respectively.

11. The method according to claim 8, wherein the first chip, the second chip and the third chip are arranged substantially along a line on the substrate, the first capillary and the second capillary moving and wire-bonding the chips along the line.
